(19) United States
(12) Patent Application Publication
(10) Pub. No.: US 2013/0324246 A1
(43) Pub. Date: Dec. 5, 2013

(54) GAME MACHINE

(71) Applicant: Konami Digital Entertainment Co., Ltd., Tokyo (JP)

(72) Inventors: Tetsuo Ishimaru, Minato-ku (JP); Yaku Hiranabe, Minato-ku (JP); Misao Yamanaka, Minato-ku (JP); Takashi Sakuma, Minato-ku (JP); Makoto Ando, Minato-ku (JP)

(73) Assignee: Konami Digital Entertainment Co., Ltd., Tokyo (JP)

(21) Appl. No.: 13/904,430

(22) Filed: May 29, 2013

(30) Foreign Application Priority Data
Jun. 1, 2012 (JP) 2012-126282

(51) Int. Cl. G07F 17/32

(52) U.S. Cl. CPC G07F 17/3211
USPC 463/31

(57) ABSTRACT

There is provided a game machine comprising: a game machine main body provided with a field where a game is played on an upper surface side thereof; and a plurality of monitors each being configured by using a flat panel display, and presenting information relating to the game to a player, wherein the game machine is provided: a support structure supporting each of the monitors above the field; and a connection device connecting each of the monitors with the support structure, and the connection device is provided with a monitor drive mechanism that moves the plurality of monitors so that a direction of display surface of each of the monitors is changed by force from a predetermined drive source.

### CROSS REFERENCE TO RELATED APPLICATION

This application claims priority to Japanese Patent Application No. 2012-126282, filed Jun. 1, 2012, the disclosure of which is hereby incorporated by reference in its entirety.

### TECHNICAL FIELD

The present invention relates to such a type of game machine that a game is played on a field provided on an upper surface side of a game machine main body.

### BACKGROUND ART

There is a well-known type of game machine that a field is provided on an upper surface side of a game machine main body, and a plurality of models representing racehorses or the like are made to travel on the field to compete for its order of arrival. As this type of game machine, generally employed is such construction that while a plurality of stations to make players to participate in a game, are arranged around the game machine main body, and a main monitor to present various kinds of information relating to a game to players is provided on an end surface side of the game machine main body.

Patent Literature: PTL1: JP-A-2006-204394.

### SUMMARY OF INVENTION

### Technical Problem

In the conventional game machine, the main monitor is installed fixedly to the end portion of the game machine main body. Accordingly, with respect to the size of a display surface of monitor, the amount of information which the monitor capable of presenting, the effect of performance using the monitor and the like, some limitation is generated. Thereby, there is a possibility that the monitor can not be used sufficiently.

Then, the aim of the present invention is providing a game machine capable of utilizing effectively the monitor by ameliorating the layout of monitor.

A game machine as one aspect of the present invention is a game machine which comprises: a game machine main body being provided with a field where a game is played on an upper surface side of the game machine main body; a plurality of monitors each being configured using a flat panel display, and presenting information relating to the game to a player; a support structure that supports each of the monitors above the field; and a connection device that connects each of the monitors with the support structure, wherein the connection device is provided with a monitor drive mechanism that moves the plurality of monitors so that a direction of display surface of each of the monitors is changed by force provided from a predetermined drive source.

According to the present invention, since a plurality of monitors are arranged in a space existing above the field, a display device can be made to approach to players staying around the game machine main body. Further, when a player seeing the field inclines his/her line of vision above, the display surface of the monitor comes in sight. Thereby, it is possible to improve the visibility of the monitor. Further, by arranging the plural monitors in a comparatively wide space existing above the field, it is possible to realize representation which is impossible to be realized by a single monitor. Thereby it is possible to present abundant amount of information to players. For example, by unifying display surfaces of two monitors or more to make the monitors function as one big size display surface, displayed is image having a high sense of presence, or a big power. When the monitors are arranged so as to face different directions from each other, it is possible to present appropriate information to each player staying at different location from each other around the game machine main body. In addition, since the direction of display surface of monitor can be changed, it is possible to present necessary information toward necessary locations. Further, it is also possible to utilize the movement of monitors itself as one portion of performance. Thereby, it is possible to utilize the monitor more effectively than before.

In one embodiment of the present invention, the number of monitors may be set to an even number that is four or more, and the monitor drive mechanism may include an arrangement switching mechanism that moves the plurality of monitors so as to be selectable between: a monitor alignment state that the plurality of monitors are arranged so as to constitute a first display device and a second display device in each of which a same number of monitors as each other are aligned side-by-side, and the monitors of the first display device and the monitors of the second display device are arranged back-to-back as the game machine main body is viewed from above; and a monitor development state that the monitors are arranged so as to make a polygonal shape around a central axis line extending in a vertical direction as the game machine main body is viewed from above.

In the monitor alignment state, the monitors are aligned side-by-side so as to form each of the first display device and the second display device. Thereby, as mentioned above, it is possible to unify the display surfaces of plural monitors to make them function as one big display device and to present abundant information to players. Further, since the monitors are arranged back-to-back between the display devices, it is possible to see any one of the display devices from almost positions existing around the game machine main body. On the other hand, in the monitor development state, the plural monitors are arranged around the central axis line extending in a vertical direction so as to from a polygonal shape. Therefore, it is possible to present information toward various directions of circumference of the game machine main body. It is possible to utilize the monitor alignment state or the monitor development state as usage or as the situation demands, and it is also possible to utilize as some performance the movement of monitors caused by situation change. It is possible to utilize the monitors further effectively by this synergetic effect.

Further, the number of monitors may be set to four, and the plurality of monitors may be arranged so as to form a quadrangle as the game machine is viewed from above in the monitor development state. Thereby, in the monitor alignment state, each two monitors are possible to be aligned side-by-side to be made to function as each display device, and in the monitor development state, it is possible to direct the monitors toward four directions of the game machine main body respectively and present appropriate information toward each of the four directions.

The connection device may include a base that is positioned so as to exist between back surfaces of the monitors in the monitor alignment state and a monitor attachment attached to each of the monitors; and the arrangement switching mechanism may be interposed between the base and the monitor attachment, and move the monitor attachment between a position corresponding to the monitor alignment state and a position corresponding to the monitor development state by the force from the drive source. According to this invention, while the base is connected to the support structure, the monitor is attached to the monitor attachment. Thereby, the monitor is supported by the support structure though the arrangement switching mechanism. By making the drive source drive, the position of monitor attachment is made to change by the arrangement switching mechanism. Thereby, it is possible to selectably switch between the monitor alignment state and the monitor development state.

In the above mentioned embodiment, while the monitor attachments of the monitors constituting the first display device are rotatably connected with each other through a hinge, the monitor attachments of the monitors constituting the second display device may be rotatably connected with each other through a hinge; the arrangement switching mechanism may include a pair of arm members that are attached to the base so as to rotate around a common spindle as a center and provided so as to intersect with each other in a state that the spindle lies between the arm members, and a motion conversion mechanism that is driven by the force from the drive source and converts motion transmitted from the drive source into rotational motion of the pair of arm members rotating around the spindle as a center in a direction opposite to each other; and Each end of the pair of arm members and the monitor attachment may be rotatably connected to each other so as to rotate around an axis line parallel to the common spindle.

According to this construction, by driving the motion conversion mechanism by the drive source, the motion transmitted from the drive source is converted into the rotational motion of each of the pair of arm members in a direction opposite to each other. The arm members are provided around the common spindle so as to intersect each other. Therefore, if each end of the arm members are rotatably connected to each monitor attachment, by the rotational motion of the pair of arm members, it is possible to make the monitor attachments corresponding to each of the first display device and the second display device move so as to bend at the hinge corresponding to each of the display devices. Thereby, it is possible to move each of the monitors between the monitor alignment state and the monitor development state.

An electric motor may be provided as the drive source, and a link mechanism may be provided as the motion conversion mechanism, the link mechanism converting rotational motion of the electric motor into rotational motion of each of the arm members. According to this invention, it is possible to move the monitors as mentioned above, with a comparatively simple construction.

Further, the monitor drive mechanism may include a pivot drive mechanism that is provided between the support structure and the base, and makes the base rotate around the central axis line by force from a predetermined drive source. According to this invention, when the base is driven to rotate around the central axis line by the pivot drive mechanism, the arrangement switching mechanism, the monitor attachments and the monitors which are attached to the base also rotate around the central axis line integrally. Thereby, it is possible to change the direction of each monitor diversely. By combining the rotation by the pivot drive mechanism and the movement of monitors by the arrangement switching mechanism, it is possible to give various kinds of motions to the monitors. Therefore, it is possible to further enhance the effect of performance using the movement of monitors. Incidentally, the monitor drive mechanism may include a pivot drive mechanism that makes each of the plurality of monitors rotate around the central axis line by force from a predetermined drive source.

In each embodiment mentioned above, in a case that an outer frame is assumed, the outer frame having a rectangular shape and circumscribing the game machine main body as the game machine main body is viewed from above, a display surface of each of the monitors may face a direction inclined obliquely with respect to both a long side and a short side of the outer frame in the monitor alignment state. According to this invention, in the monitor alignment state, since the display surface of each monitor inclines obliquely as mentioned above, the player staying at a side the display surface of monitor faces, can observe the display surface in a frontal direction or in an oblique direction. In addition, since the display surface is located above the field, when the player seeing the field inclines his/her line of vision above, the display surface comes in sight. Thereby, it is possible to visibly recognize both of the field and the monitor in a comparative easy way.

Further, the display surfaces of the plurality of monitors may face sides of the outer frame respectively in the monitor development state. Accordingly, it is possible to present information appropriately toward four directions of the game machine main body.

### Effects of Invention

As mentioned above, according to the game machine of the present invention, since a plurality of monitors are arranged in a space existing above the field, it is possible to make the display device approach players lying around the game machine main body. And, when the player seeing the field inclines his/her line of vision above, the display surface comes in sight. Accordingly, it is possible to improve the visibility of the monitor. Further, by arranging the plurality of monitors in a comparatively wide space existing above the field, it is possible to realize a display which cannot be realized by only a single monitor. By changing the direction of the display surface of each monitor, it is possible to present necessary information toward necessary locations. Further, it is possible to utilize the movement of monitors itself as a portion of performance. Accordingly, it is possible to utilize the monitor more effectively than before.

### BRIEF DESCRIPTION OF DRAWINGS

FIG. 1 is a perspective view showing an external appearance construction of a game machine according to one embodiment of the present invention.

FIG. 2 is a perspective view showing a state that station units are removed from the game machine to show major portions of a field unit and a monitor unit.

FIG. 3 is a plain view corresponding to FIG. 2.

FIG. 4 is a perspective view showing a major portion of a chassis as the game machine main body.

FIG. 5 is a perspective view showing an internal configuration of the chassis.

FIG. 6 is a diagram showing one example of a model and a self-propelling vehicle.

FIG. 7 is a diagram showing the major portion of the game machine as viewed in a direction of an arrow VII in FIG. 3.

FIG. 8 is a diagram showing the major portion of the game machine as viewed in a direction of an arrow VIII in FIG. 3.

FIG. 9 is a perspective view the state at the moment when the monitors are moved from the state shown in FIG. 2 to the monitor development state.

FIG. 10 is a plain view corresponding to FIG. 9.

FIG. 11 is a perspective view showing a major portion of the monitor support drive unit in the monitor alignment state.

FIG. 12 is a perspective view showing a major portion of the monitor support drive unit in the monitor development state.

FIG. 13 is a perspective view showing a state that the monitor support drive unit is looked up form below in the monitor development state.

FIG. 14 is a perspective view showing a major portion of an arrangement switching mechanism.

FIG. 15 is a diagram showing a state that the arrangement switching mechanism is looked up from the lower surface side in the monitor alignment state.

FIG. 16 is a diagram showing a state that the arrangement switching mechanism is looked up from the lower surface side at the moment when the arrangement of main monitors are changed from the state shown in FIG. 15.

FIG. 17 is a diagram showing a state that the arrangement switching mechanism is looked up from the lower surface side in the monitor development state.

FIG. 18A is a diagram showing a variation of the chassis.

FIG. 18B is a diagram showing another variation of the chassis.

FIG. 18C is a diagram showing a further variation of the chassis.

FIG. 19A is a diagram showing a variation of support condition of the display device.

FIG. 19B is a diagram showing another variation of support condition of the display device.

FIG. 19C is a diagram showing a further variation of support condition of the display device.

### DESCRIPTION OF EMBODIMENT

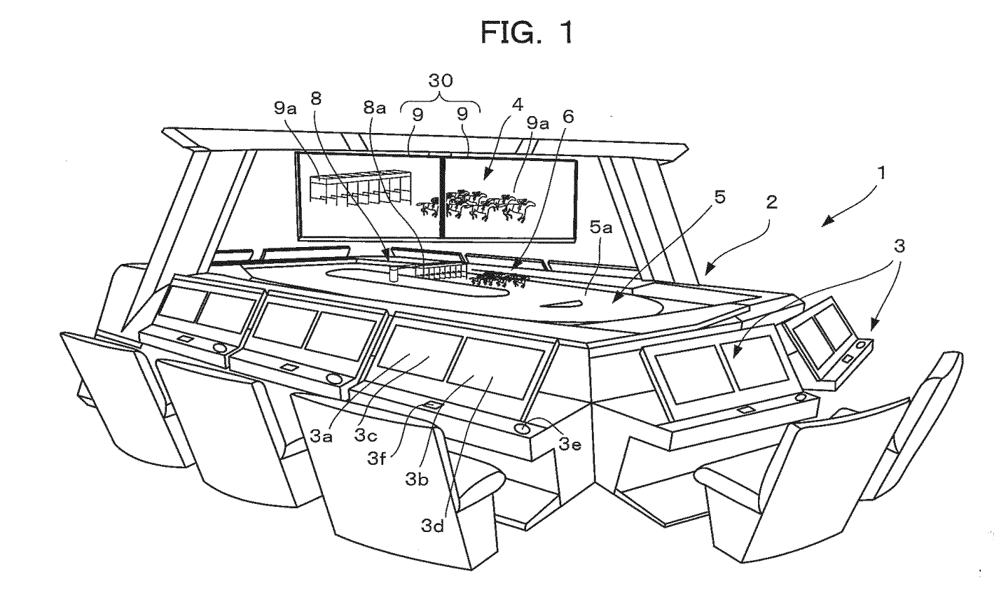

FIG. 1 is an overall view of a game machine according to one embodiment of the present invention. A game machine 1 is installed in facilities such as stores and the like, and is configured as a game machine for business use (commercial use) which allows a player to play a game in exchange for payment of play fee in a range corresponding to the play fee. The game machine 1 is a so-called medal game machine using medals as game media.

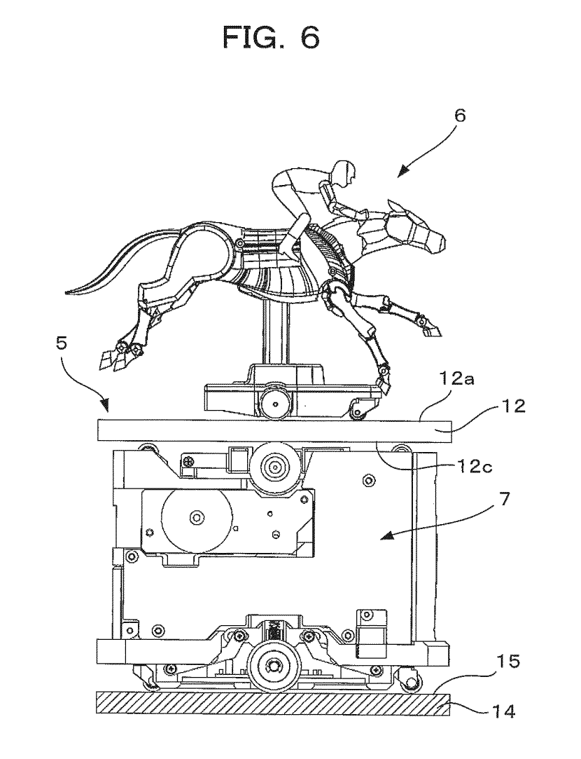

The game machine 1 includes a field unit 2, a plurality of station units 3 arranged to enclose the field unit 2, and a monitor unit 4 adjacent to the field unit 2. The game machine 1 further includes a field 5 provided on the upper surface side of the field unit 2. On the field 5, there is played a horse racing game in which a plurality of models 6 simulating racehorses run in an oval-shaped course 5a in the field 5 to compete for the arrival order. As an example of the model, the model 6 is connected to a self-propelling vehicle 7, which can run autonomously on a travel surface 15 provided in the field unit 2, by utilizing a magnet, as shown in FIG. 6, whereby the model 6 runs on the field 5 while following the self-propelling vehicle 7. The model 6 and the self-propelling vehicle 7 may be configured as appropriate, and the detailed description will be omitted. A gate unit 8 is provided at the center of the field 5. The gate unit 8 has a gate 8a to be used for aligning the models 6 in a row before the start of running. The gate 8a can be moved selectively among a position where the gate 8a is stored at the center of the field 5, a position where the gate 8a intersects the course 5a on one side of the field 5, and a position where the gate 8a intersects the course 5a on the other side of the field 5.

The station units 3 are provided as terminal devices allowing players to participate in a game executed on the field 5. The station unit 3 has first and second monitors 3a and 3b, transparent first and second touch panels 3c and 3d superposed respectively on the surfaces of the first and second monitors 3a and 3b, a medal input 3e receiving the insertion of medals, and a card reader 3f which reads a card (not shown) possessed by the player and outputs a signal corresponding to the information of the card. In each of the station units 3, one or two players can play a game. The touch panels 3c and 3d are each an already-known input device which outputs a signal corresponding to a position touched by a player's finger or the like. When a medal is inserted into the medal slot 3e, the inserted medal is converted into a credit which can be used in a horse racing game, and the credit is consumed or paid out according to the game content. The card to be read by the card reader 3f includes a nonvolatile storage medium (not shown) such as an IC chip and a magnetic stripe, and an ID unique for each card (hereinafter may be referred to as a card ID) and the like are recorded in the nonvolatile storage medium. The card ID may be recorded in the form of a bar code or the like in the card. Alternatively, instead of the card, the card ID may be recorded in storage medium such as an IC chip mounted in, for example, a portable phone.

The monitor unit 4 includes a plurality of main monitors 9 on which information associated with a game (including image and the like) is displayed. In FIG. 1, although the two main monitors 9 are arranged side by side, another two main monitors 9 are arranged on the rear side of the illustrated main monitors 9 so that the display surfaces face in a direction opposite to the illustrated main monitors 9. As the main monitor 9, used is a substantially flat plate-shaped flat panel display such as a liquid crystal display, a plasma display, and an organic EL display.

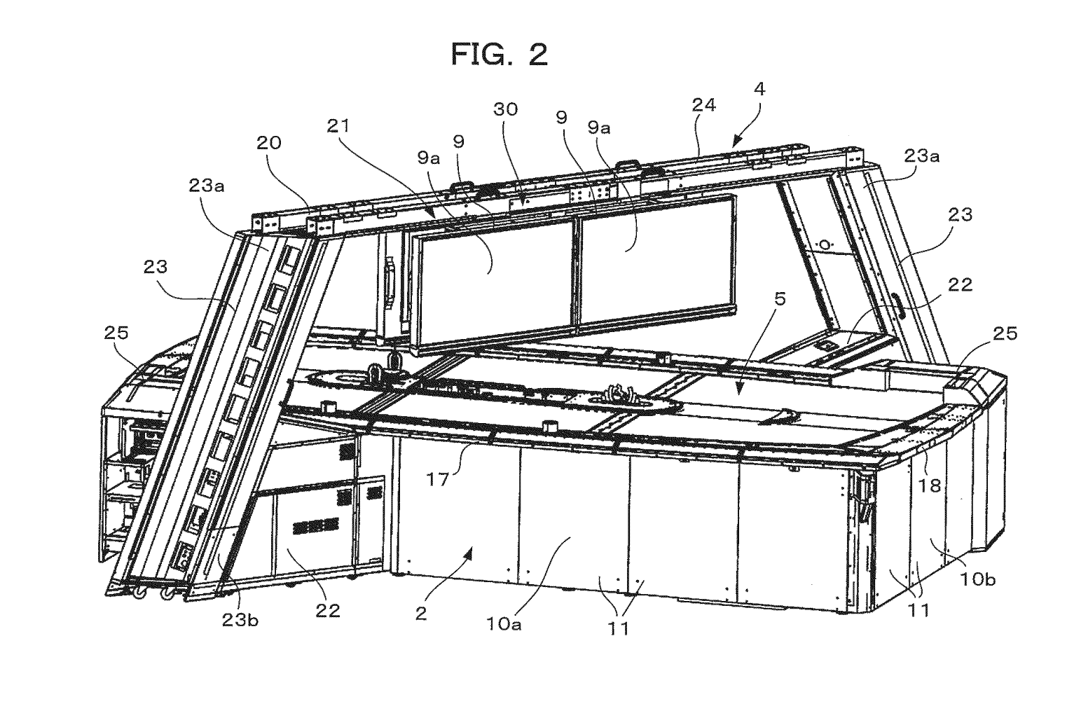

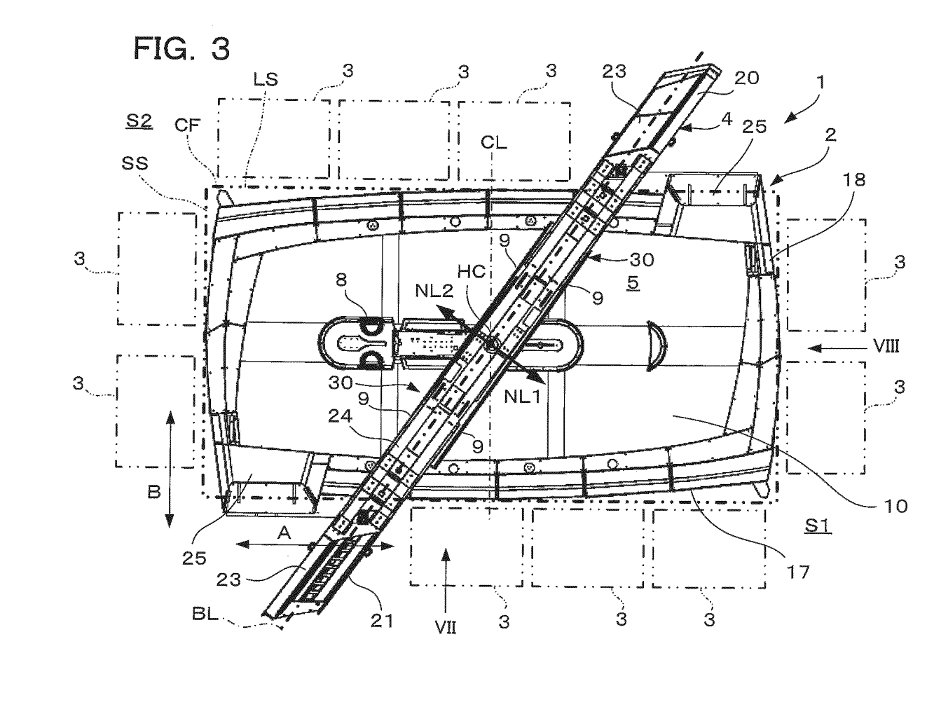

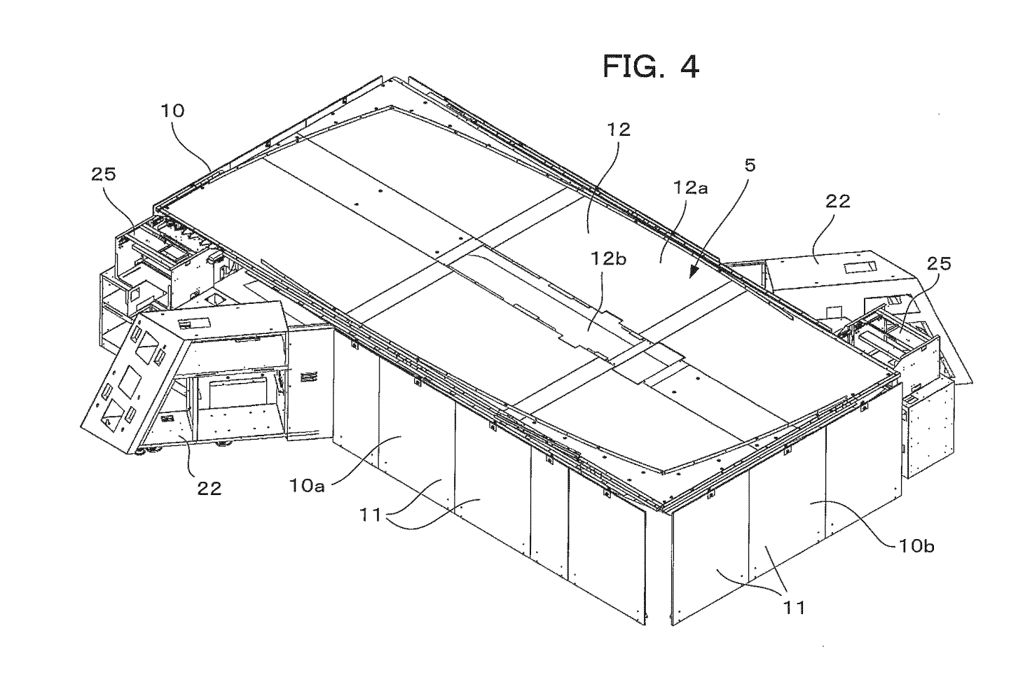

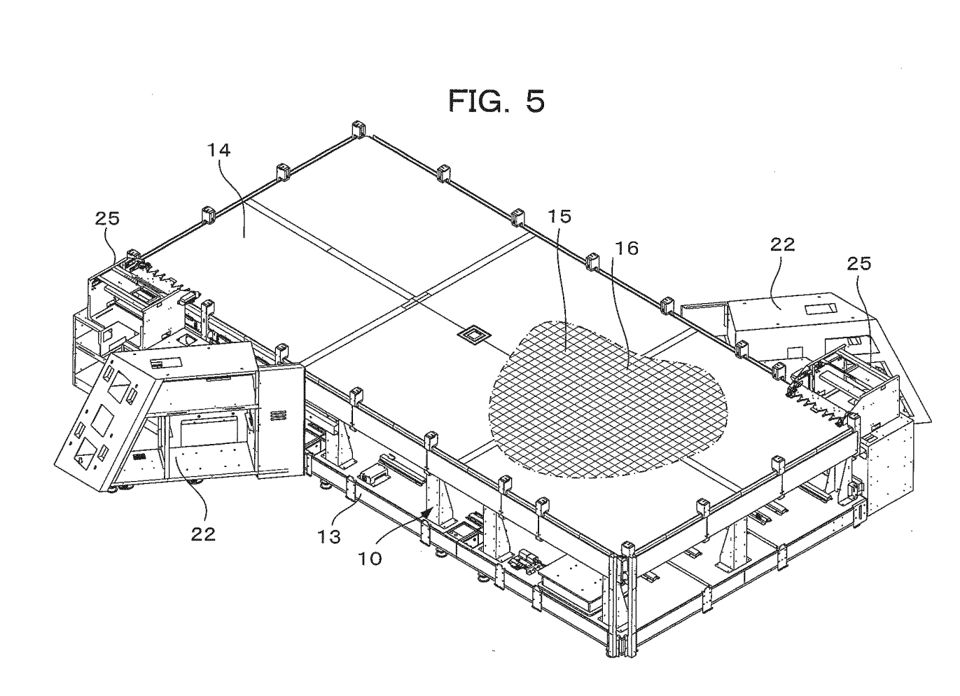

FIG. 2 shows a state in which the station unit 3 is removed from the game machine 1 to show major portions of the field unit 2 and the monitor unit 4. FIG. 3 is a plan view showing the state of FIG. 2. The field unit 2 has a chassis 10 as a major structure of the field unit 2. The chassis 10 corresponds to a game machine main body in the present invention. FIG. 4 shows a configuration of a major portion of the chassis 10 from which a decorative panel and other accessories are removed. The chassis 10 has a substantially rectangular solid shaped box structure in which a side surface 10a and an end surface 10b are covered by a side plate 11 and the upper surface side is covered by a top plate 12. The field 5 is formed on an upper surface 12a of the top plate 12. The top plate 12 has an opening 12b for housing the gate unit 8. FIG. 5 shows a state in which the side plate 11 and the top plate 12 are removed from the chassis 10. The inside of the chassis 10 is provided with a frame 13 forming a skeleton of the chassis 10. A flat plate-shaped partition 14 is provided above the frame 13. The partition 14 is installed below the top plate 12 in parallel with the top plate 12. The upper surface of the partition 14 is constructed as the travel surface 15 of the self-propelling vehicle 7, and the travel surface 15 is parallel to the upper surface 12a of the top plate 12 (see, FIG. 6). To the travel surface 15, a sensor sheet 16 is provided all over the travel surface 15, the sensor sheet 16 being used for detecting the position of the self-propelling vehicle 7. However, a detailed description of position detection of the self-propelling vehicle 7 will be omitted. A space equal to the total height of the self-propelling vehicle 7 is provided between the travel surface 15 and the lower surface 12c of the top plate 12.

Returning to FIG. 3, the chassis 10 has a shape in planar view as a combination of a first edge portion 17 and a second edge portion 18, each expanding while creating a slight arch as viewed from above. Those edge portions 17 and 18 are formed by suitably attaching a decorative panel and so on to the outer circumference of the top plate 12. In the following description, when the game machine 1 is viewed from above, the chassis 10 has a shape in planar view capable of being virtually surrounded by a rectangular outer frame CF. In the following description, the rectangular outer frame CF circumscribing the edge portions 17 and 18 of the chassis 10 as viewed from above is assumed. A direction (arrow A direction) parallel to a long side LS of the outer frame CF is referred to as a long-side direction, and a direction (arrow B direction) parallel to a short side SS of the outer frame CF is referred to as a short-side direction, whereby the directions of the game machine 1 and so on are sometimes specified.

As apparent in FIGS. 2 and 3, the monitor unit 4 has, besides the main monitor 9, a monitor support frame 20 as a support structure used for supporting the main monitor 9 above the field 5 and a monitor support drive unit 21 which connects the main monitor 9 to the monitor support frame 20 and is used for changing the direction of the main monitor 9. The monitor support frame 20 includes a pair of bases 22 attached to the chassis 10 so as to protrude from the side surface 10a of the chassis 10, a pair of columns 23 fixed to the bases 22 respectively, and a horizontal supporting beam 24 arranged so as to stride obliquely over the field 5, the both ends of which are connected to the upper ends 23a of the columns 23 respectively. The monitor support frame 20 is generally a frame-like structure having a trapezoidal shape and provided so as to stride over the field 5.

As shown in FIG. 3, when a center line CL bisecting the chassis 10 in the long-side direction is defined, one of the bases 22 is set to a position somewhat closer to the center line CL along the long side LS than one corner of the outer frame CF, and the other base 22 is set to a position somewhat closer to the center line CL along the long side LS than to another corner existing diagonally to the one corner (see, FIGS. 4 and 5). A distance between the center line CL and each of the positions where both bases 22 are installed to the chassis 10 is set equally with each other. Namely, the bases 22 are provided alternately so that the center line CL exists between the bases 22. The lower end 23b of each of the columns 23 is connected to the base 22. Thereby, the column 23 is also installed at a position closer to the center in the long-side direction than a pair of corners existing in the diagonal direction of the outer frame CF. Each of the columns 23 is arranged inclining obliquely so that the upper end 23a thereof is made closer to the upper end 23a of an opposing column 23 than the lower end 23b thereof, when the chassis 10 is viewed from above. Thereby, when the chassis 10 is viewed from above, the support beam 24 is arranged so as to stride over the field 5 along a direction inclined obliquely with respect to both the long-side direction and the short-side direction of the chassis 10. The position where the base 22 is installed to the side surface 10a of the chassis 10, i.e. the position where the column 23 is installed, is set at a substantially intermediate point between the corner of the chassis 10 and the center line CL (a central portion in the longitudinal direction of the chassis 10).

When the chassis 10 is viewed from above, the periphery of the chassis 10 is sectioned into a first region S1 and a second region S2 so that the monitor support frame 20 (more specifically, the support beam 24) lies between the first region S1 and the second region S2. The first region S1 is a region extending along one long side LS and one short side SS of the outer frame CF, and the second region S2 is a region extending along the other long side LS and the other short side SS of the outer frame CF. As shown in FIG. 1, in the first region S1, three station units 3 are arranged to face the side surface 10a of the chassis 10, and two station units 3 are arranged to face the end surface 10b of the chassis 10. The same holds for the second region S2. Although some auxiliary devices of the field unit 2, such as a charging unit 25 for charging a force supply battery of the self-propelling vehicle 7 are provided as appropriate between the base 22 and the corner of the chassis 10 (the corner is the one closer to the base 22), the details thereof will be omitted.

Returning to FIGS. 1 to 3, the description will be continued. The main monitor 9 is connected in a suspended state to a center point HC in the longitudinal direction of the support beam 24 of the monitor support frame 20 through the monitor support drive unit 21. The center point HC coincides with the center point of the chassis 10. In other words, the support beam 24 is arranged so as to pass through the center point when the chassis 10 is viewed from above. In the states of FIGS. 1 and 2, the two main monitors 9 are arranged side by side facing the first region S1 with respect to the monitor support frame 20, and another two main monitors 9 behind the main monitors 9 arranged facing the first region S1 are similarly arranged facing the second region S2. According to this constitution, a single horizontally long display device (a first display device) 30 in which the two main monitors 9 are arranged adjoiningly to each other is provided for the first region S1. Similarly, a single horizontally long display device (a second display device) 30 in which the two main monitors 9 are arranged adjoiningly to each other is provided for the second region S2. In each of the display devices 30, the display surfaces 9a of the two main monitors 9 are combined so as to be functioned as one display surface, and an image can be displayed over the display surfaces 9a. In this case, since an image can be projected on a horizontally long large screen like a movie picture, it is possible to provide a player with image having power and overfull sense of presence. Further, the display surfaces 9a may be made to display the same or different images respectively. In the following description, the state in which the main monitors 9 are aligned to provide the single display device 30 as shown in FIGS. 1 and 2 is referred to as a monitor alignment state. In FIG. 3, only one portion of the main monitor 9 is viewed along the support beam 24.

In the monitor alignment state, the display surface 9a of the main monitor 9, that is, a display surface of the display device 30 corresponding to each of the regions S1 and S2 faces a direction inclined obliquely with respect to both of the long side LS and the short side SS of the outer frame CF shown in FIG. 3. More specifically, in FIG. 3, when a bisector BL of the monitor support frame 20 is defined along the longitudinal direction of the support beam 24 of the monitor support frame 20, the display surfaces 9a of the main monitors 9 corresponding to the first region S1 are arranged so that the normal directions of the display surfaces 9a substantially coincide with a direction of an arrow NL1 perpendicular to the bisector BL. The display surfaces 9a of the main monitors 9 corresponding to the second region S2 are arranged so that the normal directions of the display surfaces 9a substantially coincide with a direction of an arrow NL2 perpendicular to the bisector BL. In other words, the main monitors 9 are arranged so that the display surface 9a of each main monitor 9 is arranged substantially parallel to the longitudinal direction of the support beam 24 (the direction of the bisector BL).

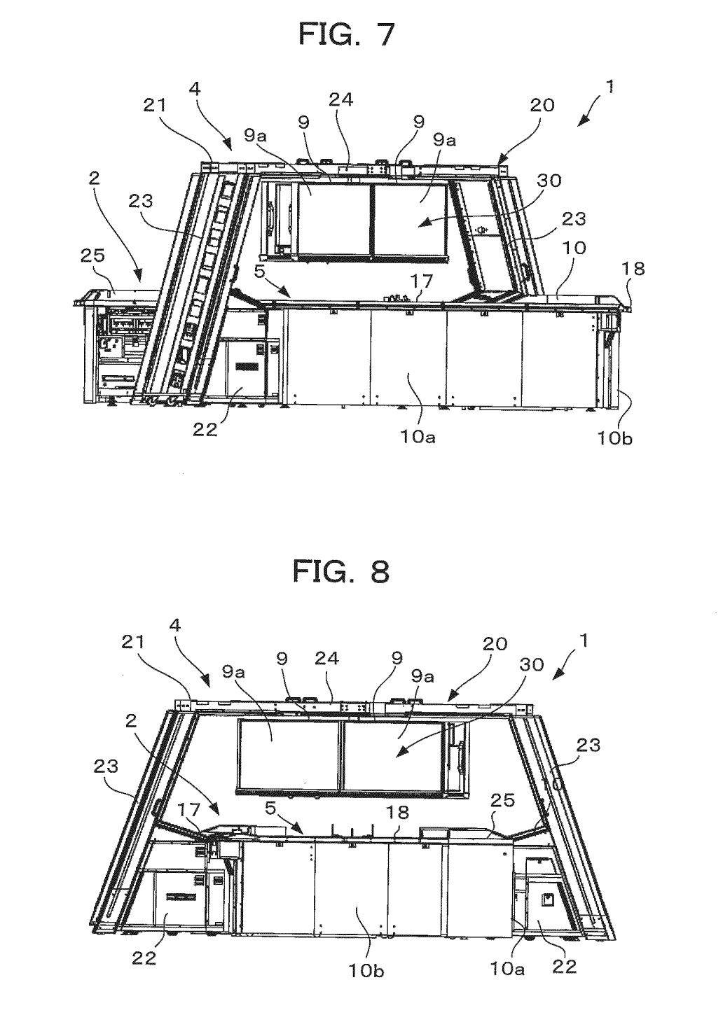

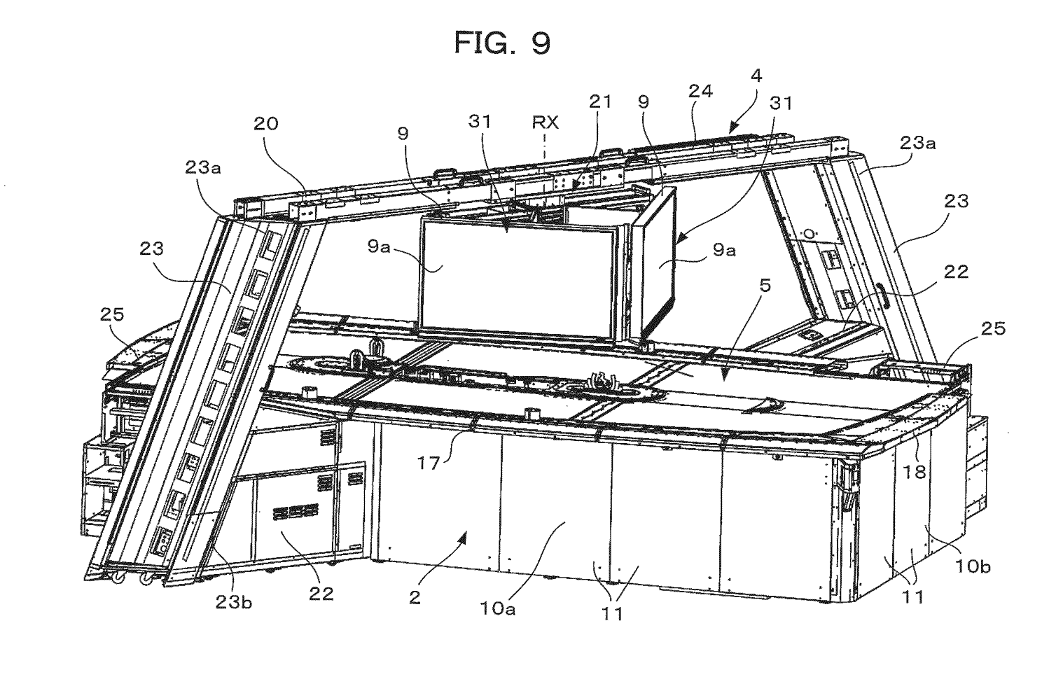

FIG. 7 is a view showing a state in which the field unit 2 in the monitor alignment state is viewed in a direction of an arrow VII of FIG. 3, that is, a state in which the chassis 10 is viewed from the long-side LS side of the outer frame CF. FIG. 8 is a view showing a state in which the field unit 2 in the same state as in FIG. 7 is viewed from a direction of an arrow VIII of FIG. 3, that is, a state in which the chassis 10 is viewed from the short-side SS side of the outer frame CF. As seen in FIGS. 7 and 8, even if the display device 30 is viewed from any of those directions, a player staying at the station unit 3 can observe the display surface 9a of the display device 30 from the front direction or an oblique direction. If the line of vision of the player points to the field 5, when the player inclines upward his/her line of vision, the display surface 9a of the display device 30 comes in his/her sight. Accordingly, with respect to moving amount between a case where the player sees the field 5 and a case where the player sees display on the display device 30, comparatively less moving amount of the line of vision of the player is required.

Since the display surfaces 9a of the display device 30 are arranged to traverse the field 5 directly above the field 5, it is possible to enhance the senses of synchronization and cooperation between a game being played on the field 5 and an image being displayed on the display device 30. For example, as shown in FIG. 1, when an image in which a state of a race being held on the field 5 is expressed by a line of vision from the station unit 3 is displayed on the display device 30, enhanced is the sense of synchronization or cooperation between the race being held on the field 5 and the race being displayed on the display device 30. Even in a state that a group of the models 6 is moved toward the back of the field 5 as viewed from a player, if the player confirms an image displayed on the display device 30, the player can naturally grasp race development, and a less moving amount of the line of vision is required at the moment. Accordingly, such a behavior of comparing the state of the field 5 and the image on the display device 30 with each other can be easily performed. Incidentally, if the display device 30 is provided along one end surface 10b (the short side SS of the outer frame CF) of the chassis 10, when a player staying on the long-side LS side of the outer frame CF sees the field 5, the player directs his/her line of vision to the front, and meanwhile, when the player sees the display device 30, the player has to turn his/her face sideways and significantly shift his/her line of vision. Thus, such an inconvenience occurs that even if the state of the race is displayed on the display device 30, it is difficult to confirm the condition of the race.

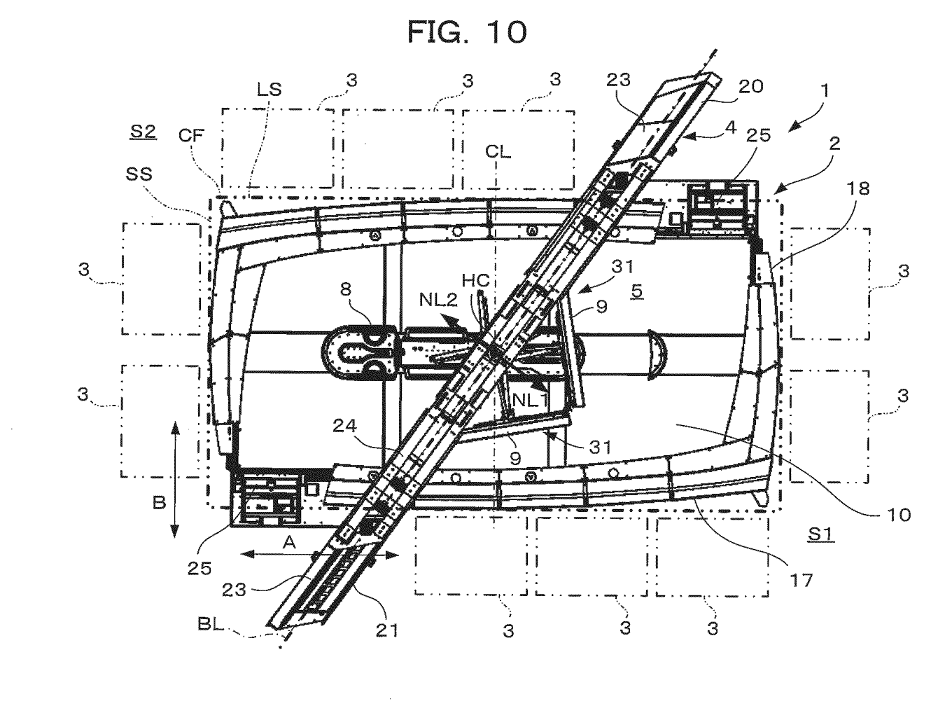

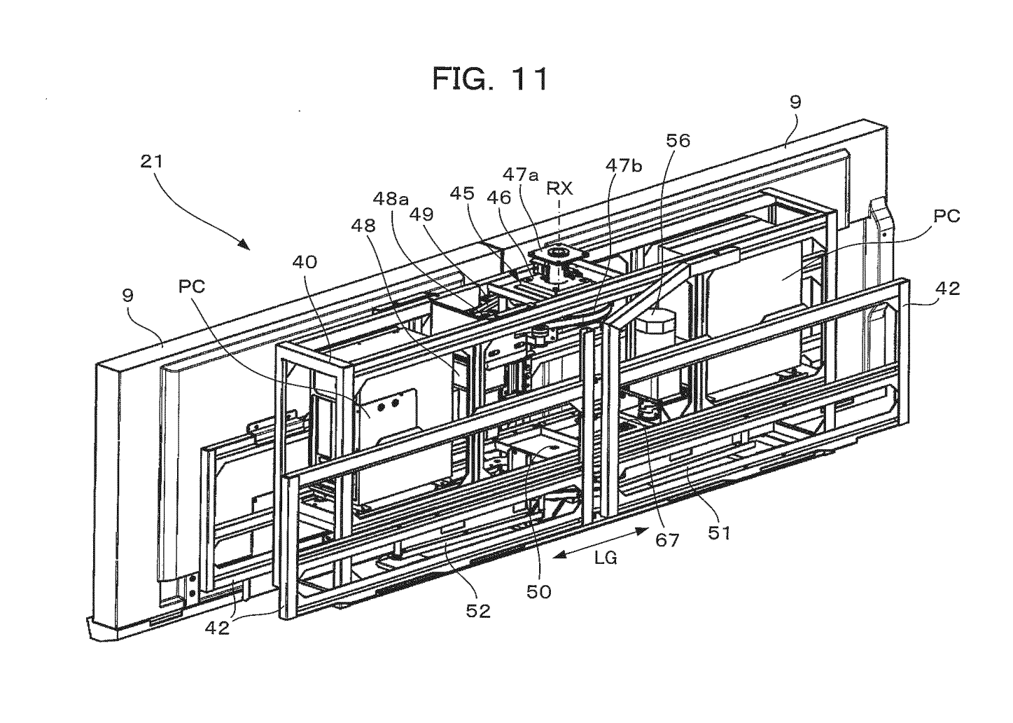

Next, the details of the monitor support drive unit 21 will be described. As described above, the monitor support drive unit 21 functions as a connection device of the main monitors 9 to the monitor support frame 20. In addition, the monitor support drive unit 21 also has a function of changing the position of each main monitor 9, i.e. the direction of the display surface 9a of each main monitor 9. Although in the above example in FIGS. 1 to 3 the main monitors 9 are aligned in each of a pair of regions S1 and S2 between which the monitor support frame 20 exists, the direction of each main monitor 9 can be changed as shown in FIGS. 9 and 10. In the example in FIGS. 9 and 10, the four main monitors 9 are arranged so as to form a substantially square when the game machine 1 is viewed from above. In this case, the display surface 9a of each main monitor 9 faces the first edge portion 17 or second edge portion 18 of the chassis 10. Namely, one main monitor 9 facing the first region S1 functions as a display device 31 for the station units 3 arranged along the first edge portion 17 in the region S1, and the other main monitor 9 facing the first region S1 functions as a display device 31 corresponding to the station units 3 arranged along the second edge portion 18 in the region S1. The same holds for the second region S2 opposite to the region S1. In FIG. 10, the illustration of the main monitors 9 facing the second region S2 is omitted. The main monitors 9 can rotate around a pivot axis line RX (FIG. 9), the pivot axis line RX extending in a vertical direction with passing through the center point HC (FIG. 9) of the support beam 24. Hereinafter, the details of the monitor support drive unit 21 will be described. As shown in FIGS. 9 and 10, a state in which each main monitor 9 faces a different direction from each other is referred to as a monitor development state. In FIG. 3, only one portion of the main monitor 9 can be recognized along the support beam 24.

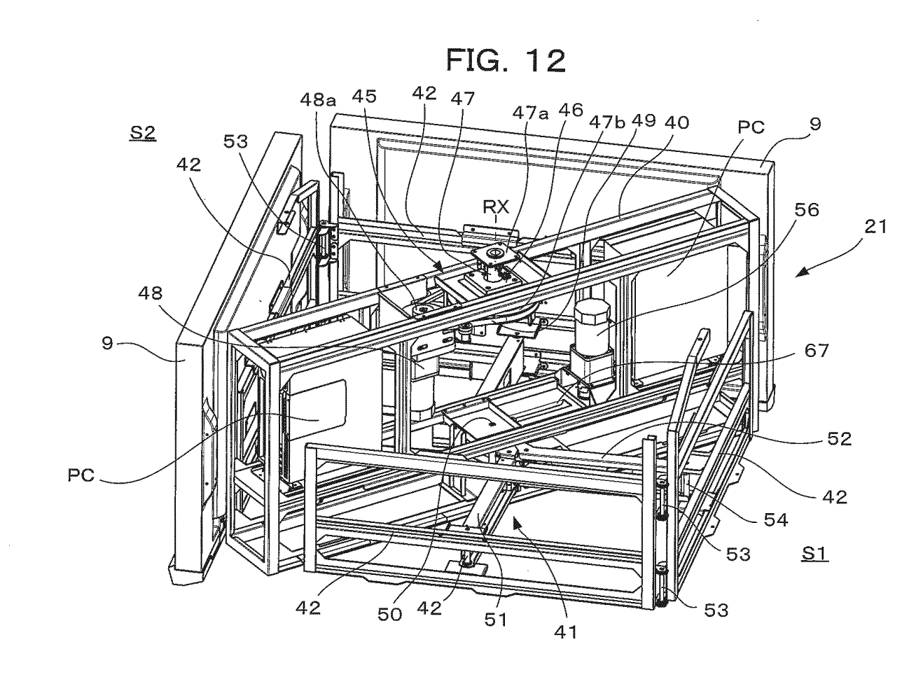

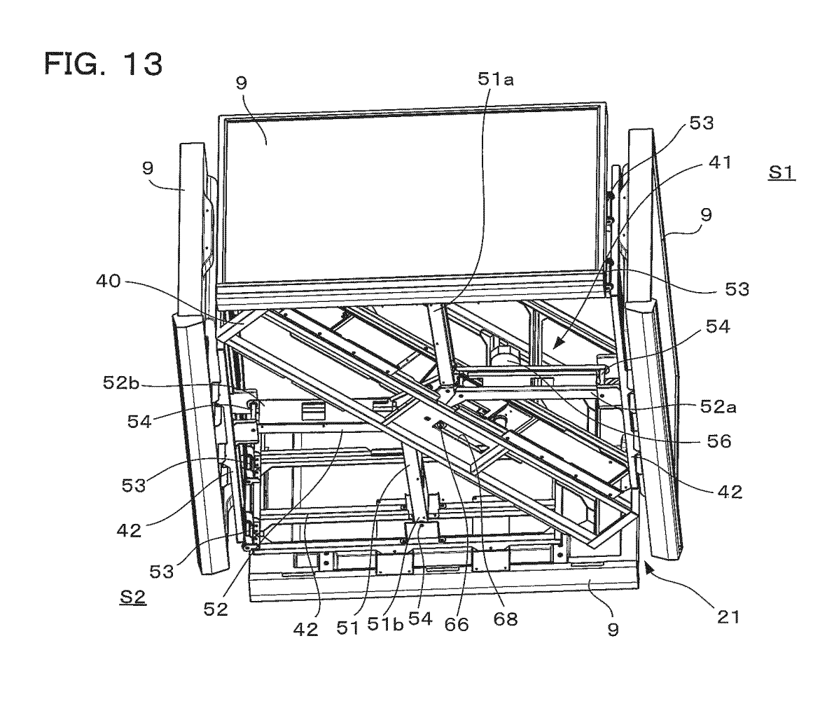

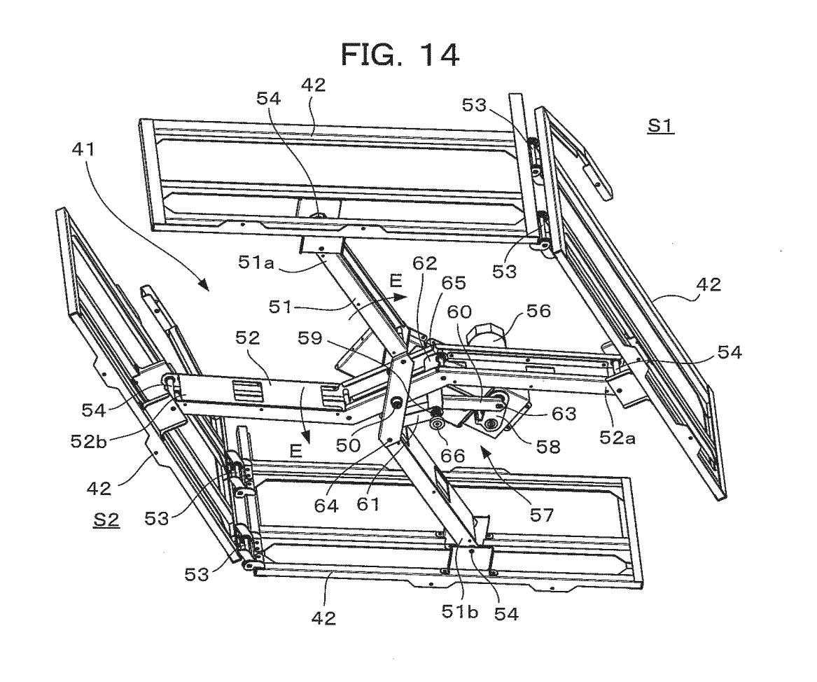

FIG. 11 shows a major portion of the monitor support drive unit 21 in a state that the two main monitors 9 on one side are removed in the monitor alignment state. FIG. 12 shows a major portion of the monitor support drive unit 21 when the state in FIG. 11 has been changed to the monitor development state. Further, FIG. 13 shows a state in which the monitor support drive unit 21 is viewed from beneath FIG. 12. As shown in these drawings, the monitor support drive unit 21 includes a base 40 having a frame structure, an arrangement switching mechanism 41 assembled with the base 40, and monitor attachments 42 each having a frame structure and mounted in the arrangement switching mechanism 41. The base 40 is a structure which becomes the base for suspending whole of the monitor support drive unit 21 and the main monitors 9 from the support beam 24 of the monitor support frame 20 and is configured as a box frame structure whose height and length are large in comparison with the thickness thereof. The base 40 is arranged so as to exist between the back surfaces of the main monitors 9 in the monitor alignment state. The longitudinal direction of the base 40 (the direction shown by an arrow LG in FIG. 11) is parallel to the display surfaces 9a in the monitor alignment state. At the both ends in the longitudinal direction of the base 40, personal computers PC handling, for example, the motion control of the main monitor 9 and the monitor support drive unit 21 are installed respectively. The monitor attachment 42 is fixed to the back surface side of the main monitor 9. The arrangement switching mechanism 41 is interposed between the base 40 and the monitor attachment 42. While functioning as a portion of means of connecting the main monitor 9 to the base 40, the arrangement switching mechanism 41 moves each monitor attachment 42 between a position corresponding to the monitor alignment state of the main monitors 9 and a position corresponding to the monitor development state.

The upper surface side of the base 40 has at its center on the upper surface side, a pivot drive mechanism 45 interposed between the monitor support frame 20 and the base 40, the pivot drive mechanism 45 being used for pivoting the four main monitors 9 around the pivot axis line RX common to the main monitors 9. As well shown in FIG. 12, the pivot drive mechanism 45 has a bearing 46 attached to the base 40 and a pivot central shaft 47 attached rotatably to the bearing 46. A flange 47a is provided with an upper end of the pivot central shaft 47. The flange 47a is fixed to the support beam 24 so that the center of the flange 47a is conformed to the center point HC (See, FIG. 3) of the support beam 24 of the monitor support frame 20. According to this constitution, the base 40 is suspended from the support beam 24 in a state the base 40 can rotate around the pivot axis line RX which passes through the center point HC in the vertical direction. A pulley 47b is concentrically fixed to a lower end portion of the pivot central shaft 47. An electric motor 48 as a drive source for pivot motion is attached to the base 40. A pulley 48a is attached to an output shaft of the electric motor 48. A drive belt 49 is wound around the pulleys 47b and 48a. Accordingly, when the electric motor 48 is driven, the base 40 is rotated around the pivot axis line RX integrally with the arrangement switching mechanism 41 and the monitor attachments 42 by the reaction force of the rotation torque of the electric motor 48. The pivot drive mechanism 45 is accompanied by a positioning mechanism, which detects the rotating position of the base 40 existing around the pivot axis line RX and stops the base 40 at a position corresponding to the monitor alignment state. The positioning mechanism may have a known configuration using an optical sensor or the like.

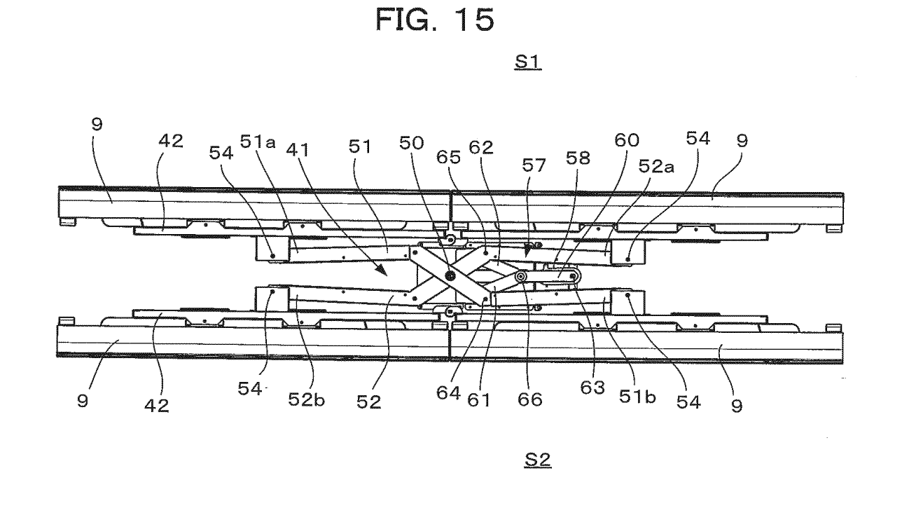

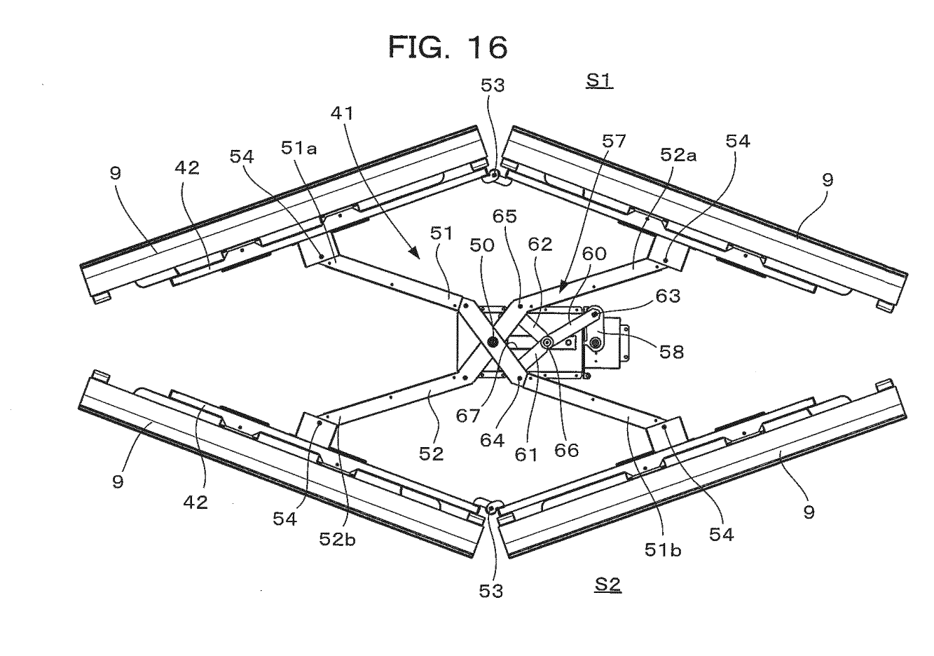

As shown in FIG. 13, the arrangement switching mechanism 41 has a pair of arm members 51 and 52 rotatably attached to the base 40 to rotate around a pin (common spindle) 50 extending in the vertical direction. As more specifically shown in FIG. 14, the monitor attachments 42 as a pair arranged on the first region S1 side are rotatably connected to each other through a hinge 53, and the monitor attachments 42 as a pair arranged on the second region S2 side are also rotatably connected to each other through the hinge 53. The arm members 51 and 52 are provided so as to intersect with each other in a state that the pin 50 lies between the arm members 51 and 52. When the main monitors 9 are in the monitor alignment state, the arm members 51 and 52 are arranged so as to be placed in a space provided between the back surfaces of the main monitors 9 (see, FIG. 15).

One end 51a of the arm member 51 is rotatably connected through a pin 54 to one of monitor attachments 42 facing the first region S1 side, and the other end 51b is rotatably connected through the pin 54 to one of monitor attachments 42 facing the second region S2 side, the monitor attachment 42 being arranged point-symmetrically with respect to the pin 50. The same holds for the arm member 52. One end 52a of the arm member 52 is rotatably connected through the pin 54 to the other one of monitor attachments 42 facing the first region S1 side, and the other end 52b is rotatably connected through the pin 54 to the other one of monitor attachments 42 facing the second region S2 side, the monitor attachment 42 being arranged point-symmetrically with respect to the pin 50. The axis lines of all pins 54 are set in the vertical direction, whereby the axis lines of the pins 54 are parallel to the axis line of the pin 50 which is the spindle of the arm members 51 and 52. Accordingly, when the arm members 51 and 52 are rotated in the opening direction (the arrow E direction in FIG. 14) around the pin 50 as the center of its rotation, the monitor attachments 42 of each of the regions S1 and S2 are displaced to be bent at the hinge 53 as the boundary, whereby the monitor development state is realized. Meanwhile, when the arm members 51 and 52 are rotated in the closing direction, the monitor attachments 42 of each of the regions S1 and S2 are displaced to be aligned around the hinge 53 as the center, whereby the monitor alignment state is realized.

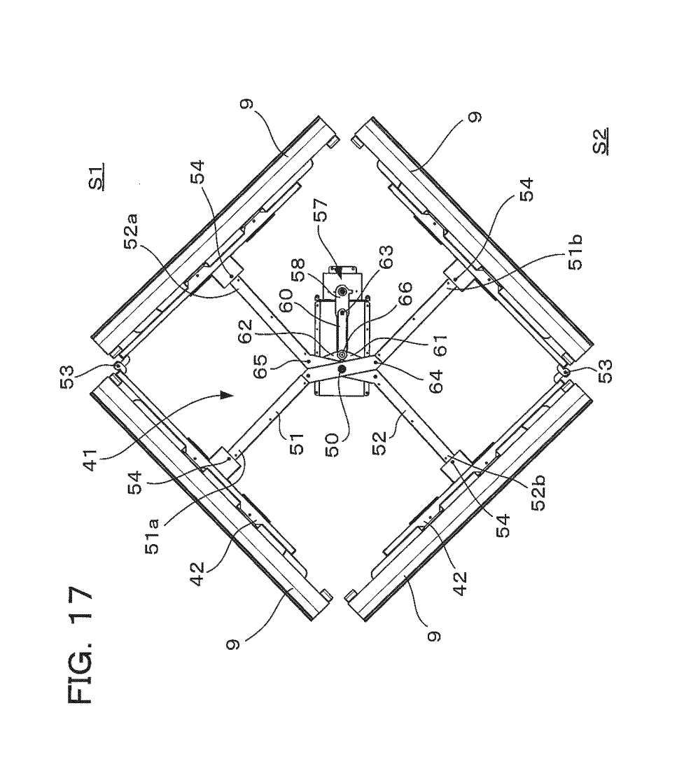

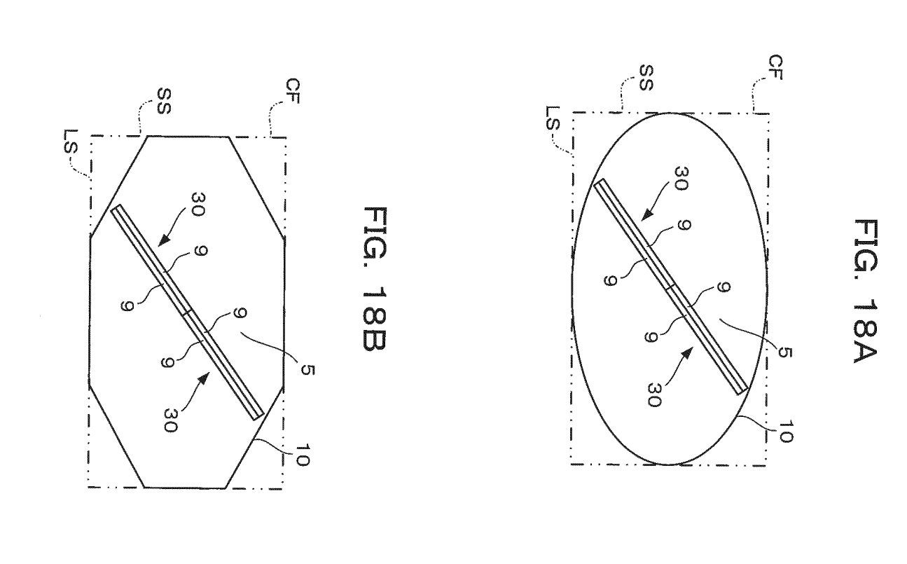

The arrangement switching mechanism 41 further includes an arm drive portion 55 which drives to rotate the arm members 51 and 52 around the pin 50. The arm drive portion 55 has an electric motor 56 as a drive source for switching arrangement and a link mechanism 57 as a motion conversion mechanism which is driven by force of the electric motor 56 and converting the rotational motion transmitted from the electric motor 56 into the rotational motions of the arm members 51 and 52 around the pin 50 as a center, the directions of the rotational motions being opposite to each other. As shown in FIGS. 16 and 17, the link mechanism 57 includes a lever 58 attached to the output shaft of the electric motor 56, a first link 60 interposed between the lever 58 and a drive pin 59, a second link 61 interposed between the drive pin 59 and the arm member 51, and a third link 62 interposed between the drive pin 59 and the arm member 52. The lever 58 and the first link 60 are rotatably connected to each other through a pin 63, and the first to third links 60 to 62 and the drive pin 59 are rotatably connected to each other around the axis line of the drive pin 59 as the center of its rotation. The second link 61 and the arm member 51 are rotatably connected to each other through a pin 64, and the third link 62 and the arm member 52 are rotatably connected to each other through a pin 65. A guide roller 66 is attached to each of the upper and lower ends of the drive pin 59. In FIG. 14, the guide roller 66 only on the lower end side is shown. As shown in FIGS. 12 and 13, the base 40 has guide holes 67 and 68 extending in parallel with the longitudinal direction of the base 40. The guide roller 66 is movably engaged to each of the guide holes 67 and 68.

FIG. 15 shows the arrangement switching mechanism 41 in the monitor alignment state. FIG. 17 shows the arrangement switching mechanism 41 in the monitor development state. FIG. 16 shows the arrangement switching mechanism 41 in an intermediate state between the monitor alignment state and the monitor development state. FIGS. 15 to 17 show a state in which the arrangement switching mechanism 41 is looked up from the lower surface side. As described above, since the guide rollers 66 are engaged to the guide holes 67 and 68 respectively, the guide roller 66 and the drive pin 59 (see, FIG. 14) coaxial with the guide roller 66 reciprocate within each of the guide holes 67 and 68. As shown in FIG. 15, in the monitor alignment state, the lever 58 and the first link 60 overlap each other along a direction parallel to the guide hole 67. When the lever 58 is driven to rotate by the electric motor 56 (see, FIG. 14) in this state, the directions of the lever 58 and the first link 60 are displaced from each other as shown in FIG. 16, and the lever 58 rotates to push the first link 60 toward the left of FIG. 16. According to this constitution, both a connecting point between the second link 61 and the drive pin 59 and a connecting point between the third link 62 and the drive pin 59 are also pushed in the same direction, and the motion is transmitted to the arm members 51 and 52 through the links 61 and 62. Consequently, the arm members 51 and 52 start to open, and in coordination with this motion of them, the monitor attachments 42 start the motion so as to be bent at the hinge 53 as an axis.

As shown in FIG. 17, when the lever 58 rotates to a position where the lever 58 is aligned with the first link 60, the guide roller 66 and the drive pin 59 are maximally moved toward the left of FIG. 17, and the opening angle between the arm members 51 and 52 becomes maximized. Consequently, the directions of the main monitors 9 change into the monitor development state. When the lever 58 further rotates over the position of FIG. 17, the drive pin 59 is pulled toward the right of FIG. 17 through the first link 60. When the lever 58 rotates by 180° from the position of FIG. 17, the directions of the main monitors 9 change into the monitor alignment state shown in FIG. 15. The arrangement switching mechanism 41 is accompanied by a positioning mechanism, which detects a position of the lever 58 in the monitor alignment state and a position of the lever 58 in the monitor development state, and stops the lever 58 at each position. The positioning mechanism may have a known configuration using an optical sensor and others.

According to the game machine 1 of this embodiment, since the direction of the main monitor 9 can be changed between the monitor alignment state and the monitor development state, using the arrangement switching mechanism 41 of the monitor unit 4, the direction of the monitor 9 can be changed as usage. In the monitor alignment state, as described above, the single display device 30 can be configured by combining the two main monitors 9. Accordingly, it is possible to realize a mode of use in which the condition of a race and so on are displayed to enhance the sense of presence. In this case, the display surface of the display device 30 is directed in the oblique direction, whereby the above advantage can be obtained. Meanwhile, when the direction of the main monitor 9 is changed to the monitor development state, the display surface 9a of the main monitor 9 can be seen almost frontally from the station units 3 at any position around the chassis 10. Accordingly, for example, when displayed are relatively small characters or the like such as the odds before a race and announcement of poll closing, or when a size of image is limited to the aspect ratio of one main monitor 9, the image can be suitably displayed. The main monitor 9 is operated between the monitor alignment state and the monitor development state, whereby a nonconventional novel performance effect can be generated. Further, a novel performance can also be generated by rotating the main monitor 9 around the pivot axis line RX with using the pivot drive mechanism 45. It is also possible to add a further visible effect by driving simultaneously the arrangement switching mechanism 41 and the pivot drive mechanism 4. It is obvious that image for visible effect may be displayed on the main monitors 9 in process of changing the directions thereof.

In the above embodiment, both of the arrangement switching mechanism 41 and the pivot drive mechanism 45 function as the monitor drive mechanism. However, the monitor drive mechanism of the present invention does not always require that the mechanisms 41 and 45 are provided therein. For example, only the arrangement switching mechanism 41 is provided, and the base 40 of the arrangement switching mechanism 41 is fixed to the monitor support frame 20, whereby the pivot drive mechanism 45 may be omitted. The monitor drive mechanism is not limited to an example including the arrangement switching mechanism 41 and the pivot drive mechanism 45, and various configurations can be adopted as long as a plurality of monitors can be moved so that the directions of the display surfaces of the monitors are changed. The monitor drive mechanism may be configured so that each of the monitors can independently move. The term “movement” may include various kinds of operations as long as the direction of the display surface of the monitor can change and may include not only a simple rotational motion but also the following motions: a motion in which rotational motions are combined; a motion in which the rotational motion and a linear motion are combined; and the like.

The configuration of the arrangement switching mechanism is not limited to the above embodiment and may be changed as appropriate as long as the directions of the monitors can be switched between the monitor alignment state and the monitor development state. For example, although the directions of the monitors are changed by using the link mechanism and a pair of the arm members in the above embodiment, a portion of or whole link mechanism may be replaced with a well-known motion conversion mechanism such as a cam mechanism.

In the above embodiment, the column 23 of the monitor support frame 20 as a support structure of the monitor 9 is deviated toward the center in the long-side direction of the outer frame CF from the corner of the chassis 10, and the column 23 is arranged so that the upper end 23a of the column 23 is closer than the lower end 23b thereof to the upper end 23a of the opposing column 23. According to this constitution, the total length of the support beam 24 can be reduced. The reduction of the total length of the support beam 24 can lead to reduction of flexure, and it is advantageous in strength. The space formed between a pair of the columns 23 can be satisfactorily filled with the two main monitors 9. According to this constitution, reduced is a possibility that the space between the columns 23 produces spacious atmosphere, and a possibility of occurrence of such measures that an additional component like a decorative panel is installed between the monitor 9 and the column 23 to improve the design is eliminated. However, no elimination is performed in taking such measures.

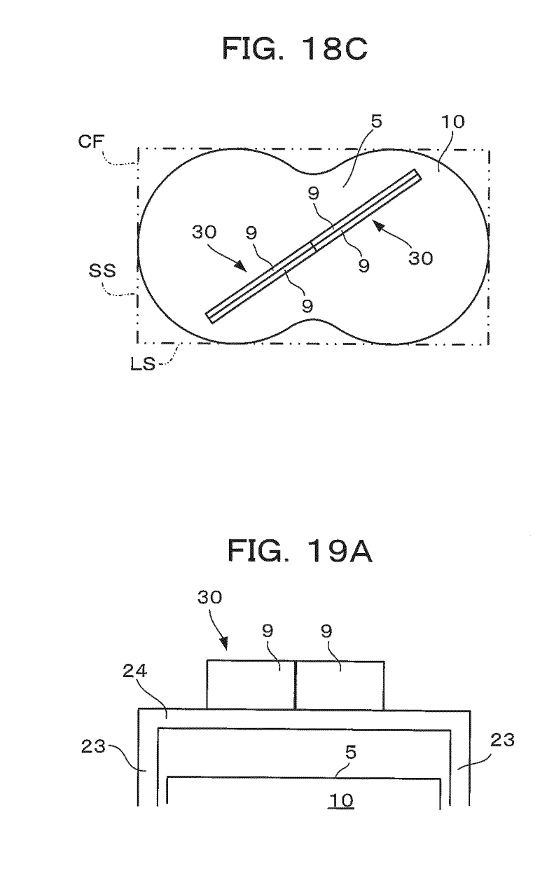

The game machine main body is not limited to the example in which the shape in plan view of the outer circumference thereof is a rectangular shape or a shape approximating the rectangular shape. The configuration of the game machine main body may be changed as appropriate as long as a field is provided on the upper surface side thereof. In the monitor alignment state, if a constitution in which the display surface of each monitor is inclined obliquely with respect to both the long-side direction and the short-side direction of a virtual outer frame with respect to the game machine main body is adopted, the shape of the game machine main body is not limited to a substantially rectangular shape as viewed from above. For example, even if engaged as the game machine main body is the chassis 10 having an elliptical shape as shown in FIG. 18A, the chassis 10 having a polygonal shape as shown in FIG. 18B (octagonal shape in FIG. 18B), or the transformational chassis 10 formed by connecting curved lines as shown in FIG. 18C, the outer frame CF that circumscribes each of these chasses 10 is assumed, and the display surface of the display device 30 can be directed so as to be inclined obliquely with respect to both of the direction of the long side LS and the direction of the short side SS of the outer frame CF.

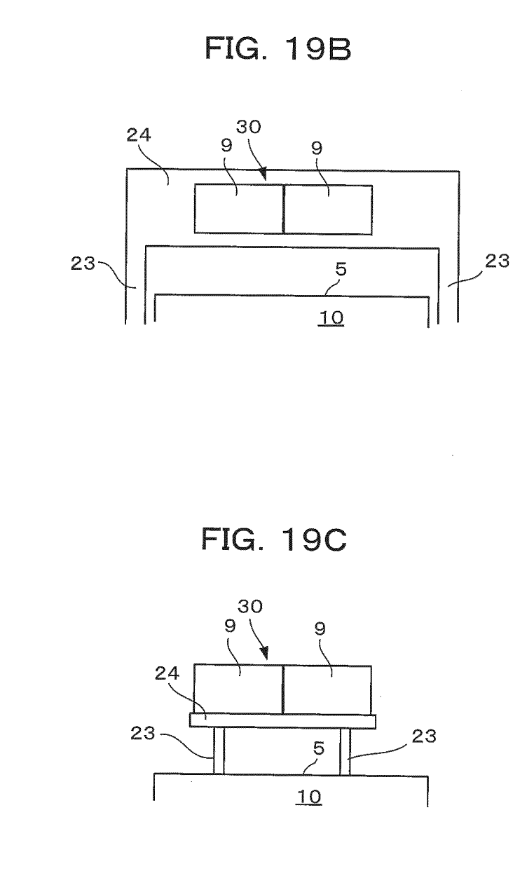

The structure supporting the monitor is not limited to the example in which the monitor is suspended from the frame-like structure as described above. For example, as shown in FIG. 19A, the monitors 9 may be placed on the support beam 24 striding over the field 5, or as shown in FIG. 19B, the monitors 9 may be provided to be embedded in the support beam 24 striding over the field 5. Alternatively, as shown in FIG. 19C, there may be constituted a support structure so that one or a plurality of the columns 23 protrude from suitable positions of the field 5 and the support beam 24 is equipped on the tops of columns 23 to support the monitor 9. When the center of the field 5 is a void space, a support structure may be installed in the central portion to support the monitors 9. In the embodiment of FIG. 19C, the monitors 9 may be also supported by being suspended, may be supported from below, or may be supported by being embedded. The support beam is not limited to a linear beam extending in a horizontal direction, and an arch-like bending beam may be employed.

In the present invention, the number of monitors is not limited to four, and two or an even number of four or more monitors may be provided. When two monitors are provided, the monitors may be driven by a monitor drive mechanism so that the directions of the display surfaces of the monitors are changed respectively. When an even number of four or more monitors are provided, for constituting the first and second display devices having the same number of the monitors as each other, the monitors are arranged side by side, and the monitors are moved so that the monitors of the first display device and the monitors of the second display device are arranged back-to-back as a game machine main body is viewed from above, whereby the monitor alignment state can be realized. In this case, in the monitor development state, the monitors may be aligned in a polygonal shape having the same number of apexes as the number of the monitors which are installed.

In the above embodiment, although a plurality of the station units 3 are arranged around the chassis 10 as the game machine main body, the station units are not necessarily required in the present invention. A portion corresponding to the station unit may be provided integrally with a portion of the game machine main body. The game machine to which the invention is applied is not limited to the example in which the models run on the field. There may be used a game machine in which a game is played using game media, such as medals, balls, and cards, on the field. At least a portion of the field may be configured as a virtual field using an image. At least a portion of the field may be configured sterically or three-dimensionally.

What is claimed is:

1. A game machine comprising:
a game machine main body being provided with a field where a game is played on an upper surface side of the game machine main body;
a plurality of monitors each being configured using a flat panel display, and presenting information relating to the game to a player;
a support structure that supports each of the monitors above the field; and
a connection device that connects each of the monitors with the support structure, wherein
the connection device is provided with a monitor drive mechanism that moves the plurality of monitors so that a direction of display surface of each of the monitors is changed by force provided from a predetermined drive source.

2. The game machine according to claim 1, wherein
the number of monitors is set to an even number that is four or more, and
the monitor drive mechanism includes an arrangement switching mechanism that moves the plurality of monitors so as to be selectable between: a monitor alignment state that the plurality of monitors are arranged so as to constitute a first display device and a second display device in each of which a same number of monitors as each other are aligned side-by-side, and the monitors of the first display device and the monitors of the second display device are arranged back-to-back as the game machine main body is viewed from above; and a monitor development state that the monitors are arranged so as to make a polygonal shape around a central axis line extending in a vertical direction.

3. The game machine according to claim 2, wherein
the number of monitors is set to four, and
the plurality of monitors are arranged so as to form a quadrangle as the game machine is viewed from above in the monitor development state.

4. The game machine according to claim 3, wherein:
the connection device includes a base that is positioned so as to exist between back surfaces of the monitors in the monitor alignment state and a monitor attachment attached to each of the monitors; and
the arrangement switching mechanism is interposed between the base and the monitor attachment, and moves the monitor attachment between a position corresponding to the monitor alignment state and a position corresponding to the monitor development state by the force from the drive source.

5. The game machine according to 4, wherein:
while the monitor attachments of the monitors constituting the first display device are rotatably connected with each other through a hinge, the monitor attachments of the monitors constituting the second display device are rotatably connected with each other through a hinge;
the arrangement switching mechanism includes a pair of arm members that are attached to the base so as to rotate around a common spindle as a center and provided so as to intersect with each other in a state that the spindle lies between the arm members, and a motion conversion mechanism that is driven by the force from the drive source and converts motion transmitted from the drive source into rotational motion of the pair of arm members rotating around the spindle as a center in a direction opposite to each other; and
Each end of the pair of arm members and the monitor attachment are rotatably connected to each other so as to rotate around an axis line parallel to the common spindle.

6. The game machine according to claim 5, wherein
an electric motor is provided as the drive source, and a link mechanism is provided as the motion conversion mechanism, the link mechanism converting rotational motion of the electric motor into rotational motion of each of the arm members.

7. The game machine according to claim 4, wherein
the monitor drive mechanism includes a pivot drive mechanism that is provided between the support structure and the base, and makes the base rotate around the central axis line by force from a predetermined drive source.

8. The game machine according to claim 2, wherein
the monitor drive mechanism includes a pivot drive mechanism that makes each of the plurality of monitors rotate around the central axis line by force from a predetermined drive source.

9. The game machine according to claim 2, wherein
in a case that an outer frame is assumed, the outer frame having a rectangular shape and circumscribing the game machine main body as the game machine main body is viewed from above, a display surface of each of the monitors faces a direction inclined obliquely with respect to both a long side and a short side of the outer frame in the monitor alignment state.

10. The game machine according to claim 9, wherein
the display surfaces of the plurality of monitors face sides of the outer frame respectively in the monitor development state.
